(19) United States
(12) Patent Application Publication
(10) Pub. No.: US 2019/0056037 A1
(43) Pub. Date: Feb. 21, 2019

(54) DISTRIBUTION VALVE

(71) Applicant: TACONOVA GROUP AG, Zurich (CH)

(72) Inventors: Serdar Kalfa, Zurich (CH); Lothar Dickenscheid, Schlieren (CH)

(21) Appl. No.: 16/088,960

(22) PCT Filed: Apr. 25, 2016
(86) PCT No.: PCT/CH2016/000071

§ 371 Date: Sep. 27, 2018

(51) Int. Cl. F16K 11/10; F16K 27/02; F16K 3/24

(52) U.S. Cl. CPC F16K 11/105; F16K 3/24; F16K 27/0209

(57) ABSTRACT

The invention concerns a distribution valve for the use in the feed or return of a medium circuit, with a housing (1) forming the feed line or the return line, respectively, a branch line (2) branching off from the housing (1) and an adjusting unit (3) for adjustment of a flow of medium through the branch line (2), which adjusting unit is formed separately from the housing (1) and opposite to the branch line (2) is arranged at the housing (1) and protrudes the housing wall. The adjusting unit (3) comprises an adjusting spindle (4), the axial position of which with respect to a component (5) of the adjusting unit (3) which is connected to the housing (1) can be changed by twisting it relative to said component (5), thereby changing the flow rate. The valve is designed in such a manner that an axial movement of the adjusting spindle (4) relative to the component (5) in direction towards the branch line (2) effectuates an increase of the flow rate through the branch line (2). Furthermore, adjustable stopper means are present, by means of which, through abutting of a first abutment face (7) which is connected with the adjusting spindle (4) against a second abutment face (8) which is connected with the housing (1), an axial movement of the adjusting spindle (4) with respect to the component (5) in direction towards the branch line (2) can be limited at a specific axial position, for limiting the maximum flow rate through the branch line (2) that can be adjusted.

The invention makes it possible to provide in a cost-efficient manner very compact and simple designed distribution valves at which a once adjusted limitation of the maximum flow rate is preserved in case of a temporarily closing or decrease of the flow rate.

### TECHNICAL FIELD

The invention relates to a distribution valve, to a distribution arrangement comprising such distribution valves as well as to an adjusting unit or adjusting and measuring unit, respectively, for such a distribution valve according to the preambles of the independent claims.

### PRIOR ART

Distribution valves are applied in cases where from a main line one or more discharge lines shall be branched off. In combination with a flow measuring device they are preferably employed in cases where the flow of a medium through a piping system shall be adjusted for a longer period to a specific value and at the same time shall permanently and directly be visually readable. In particular in the field of building equipment and appliances, such distribution valves are increasingly employed for the adjustment of the flow of warm water through individual warm water heating circuits. In that cases, preferably a plurality of distribution valves are formed for a respective number of heating circuits in that a distribution manifold, which serves as common housing and as common feed for the distribution valves, is equipped with a respective number of valve units. These consist in each case of a branch line for connection to the feed of the heating circuit and of an adjusting unit for adjusting or of an adjusting and measuring unit for adjusting and indicating the flow rate in the branch line, respectively, which are screwed into opposite tapped holes in the distribution manifold.

In such arrangements, the balancing of all heating circuits needs to be done in conjunction, since they form a common hydraulic system and therefore influence each other. This is quite a laborious undertaking, which in addition requires a lot of experience. Thus, it is important that in case of an intervention at one of the heating circuits which requires a temporary separation of this circuit by means of its distribution valve from the overall system, e.g. in order to exchange a water-bearing component, subsequently the original flow rate can be re-adjusted, without requiring again laborious balancing measurements.

From the company Strawa Wärmetechnik GmbH in Germany, a distribution valve with flowmeter is known under the name “Regolux”, which has a stopper hood that is screwed to it at the outside of the valve housing, which stopper hood provides an axial stop for the definition of a maximum valve opening and the position of which can be changed by twisting relative to the housing. This hood is locked in the respective adjusted position by means of an additional securing ring. This solution, however, has the disadvantage that it requires a lot of installation space. Moreover, this valve is formed by a lot of components, which is undesirable since these valves are exposed to a vast pricing pressure, making it a continuous desire to reduce the manufacturing costs of such valves.

### DISCLOSURE OF THE INVENTION

Therefore, it is an objective to provide distribution valves which do not show the before mentioned disadvantages of the prior art or avoid them at least partially.

This objective is achieved by the distribution valve as well as by the adjusting unit and the adjusting and measuring unit, respectively, for such a distribution valve according to the independent claims.

Accordingly, a first aspect of the invention concerns a distribution valve which is suitable for the use in the feed or return of a medium circuit for heating or cooling, in particular in the field of building equipment and appliances.

The distribution valve comprises a housing forming the feed line or the return line, respectively, a branch line branching off from the housing as well as an adjusting unit for adjustment of a flow rate of the medium through the branch line, which adjusting unit is formed separately from the housing and opposite to the branch line is arranged at the housing and protrudes the housing wall.

The adjusting unit further comprises an adjusting spindle, the axial position of which with respect to a component of the adjusting unit which preferably is fixedly connected to the housing can be changed by twisting it relative to said component, thereby simultaneous changing the flow rate through the branch line in such a way that an axial movement of the adjusting spindle relative to this component in direction towards the branch line effectuates an increase of the flow rate through the branch line, and that an axial movement of the adjusting spindle relative to this component in direction away from the branch line effectuates an decrease of the flow rate through the branch line.

Furthermore, the distribution valve comprises adjustable stopper means, by means of which, through abutting of a first abutment face which is connected with the adjusting spindle against a second abutment face which is connected with the housing, an axial movement of the adjusting spindle with respect to the component of the adjusting unit, relative to which it is twisted as described before for adjusting the flow rate through the branch line, in direction towards the branch line is limited at a specific axial position, for limiting the maximum flow rate through the branch line that can be adjusted.

The invention makes it possible to provide in a cost-efficient manner very compact and simple designed distribution valves at which a once adjusted limitation of the maximum flow rate is preserved in case of a temporarily closing or decrease of the flow rate.

In a preferred embodiment of the distribution valve, the second abutment face is formed by the component of the adjusting unit which is connected with the housing, with respect to which the adjusting spindle with the effect that the flow rate through the branch line is changed is twisted according to the claims, or the second abutment face is connected with this component. By this, the advantage results that the stopper means can be realized integrally within the adjusting unit, which typically is sold as readily assembled component for distribution valves according to the preamble of claim 1, so that the number of valve components that need to be administered for providing the distribution valves according to the invention can be kept small and interfacing problems between separately purchased components can be avoided from the beginning.

In a further preferred embodiment, the distribution valve is designed in such a manner that the first abutment face is facing towards the branch line and that it, for limiting the maximum flow rate through the branch line that can be adjusted, in axial direction in relation to the twisting and displacement axis of the adjusting spindle abuts against the second abutment face. This construction principle makes possible a simple and sturdy design. The before said in contrast to abutment faces also covered by the invention which act in rotation direction of the adjusting spindle.

In still a further preferred embodiment, the distribution valve in addition to the adjusting unit for adjusting the flow rate through the branch line also comprises a measuring unit for measuring the adjusted flow rate through the branch line and for displaying same at the outside of the distribution valve.

In this case it is preferred that the adjusting unit and the measuring unit are commonly formed as a combined adjusting and measuring unit. By this the advantage is arrived at that a compact construction of such valves is achieved and also here the number of valve components that need to be administered for providing the distribution valves according to the invention can be kept small.

The adjustable stopper means by advantage can be locked in the adjusted position, so that an unintended alteration of the adjusted maximum flow rate through the branch line certainly is prevented.

In case the position of the first abutment face of the adjustable stopper means is adjustable, in particular its axial position with respect to the adjusting spindle, which is preferred, an especially simple construction becomes possible, in that an outer thread of the adjusting spindle which causes the axial movement of said spindle can be used to carry a component which provides the first abutment face (abutment component according to the claims), for example a stopper nut arranged on this thread, the axial position of which with respect to the adjusting spindle by twisting on said thread can be adjusted.

By this it furthermore becomes possible to fixedly connect the second abutment face with the housing or with the component of the adjusting unit, respectively, relative to which the adjusting spindle according to the claims for adjusting the flow rate through the branch line is twisted, e.g. by being formed in one-piece design together with said, which as well is preferred since also by this a compact and simple construction with only few components is promoted.

According to an alternative preferred embodiment it is also envisaged to design the distribution valve in such a manner that the position of the second abutment face, in particular its axial position, with respect to the housing or the component of the adjusting unit, respectively, relative to which the adjusting spindle according to the claims for adjusting the flow rate through the branch line is twisted, is adjustable.

By this it then becomes possible to design the adjusting spindle with a first abutment face fixedly arranged at it, which makes possible an especially simple design of it.

In doing so it is preferred, in case that the first abutment face is formed by an abutment component which is mounted on an outer thread of the adjusting spindle, so that its axial position with respect to the adjusting spindle can be adjusted by twisting relative to the adjusting spindle, and in case that at the same time the adjustable stopper means can be locked in the adjusted position in order to safely prevent an unintended alteration of the adjusted maximum flow rate through the branch line, that in the respective adjusted axial position of the abutment component with respect to the adjusting spindle its rotatory position on the adjusting spindle can be locked with the locking means, preferably by rotatory positive locking with the adjusting spindle. This makes possible a precise and sturdy locking of the abutment component in the adjusted position.

In doing so it is further preferred that the locking means comprise a ring or a hood, which in a rotatably positive locking manner engages contours formed at the circumference of the adjusting spindle and at the circumference of the abutment component or in a positive manner encompasses such contours.

Preferrably, this ring or hood, for locking the rotatory position of the abutment component, is pushed in axial direction towards the branch line onto the abutment component and axially latches in the position, in which it locks the rotatory position of the abutment component, with the abutment component and/or with the adjusting spindle. Such locking means have proven to be especially practical and space-saving.

Preferrably, this latching and with it the locking can only be cancelled by damaging or destroying the ring or the hood, so that it is visually recognizable if possibly an alteration of the originally adjusted maximum flow rate through the branch line has taken place or not.

Furthermore the distribution valve, in the before mentioned embodiments in which the locking means comprise a ring or hood which in a rotatably positive locking manner engages contours formed at the circumference of the adjusting spindle and at the circumference of the abutment component or in a positive manner encompasses such contours, preferably that this ring or hood, for releasing the locking of the rotatory position of the abutment component, in an axial direction pointing away from the branch line has to be removed from the abutment component, wherein it is further preferred that the ring or the hood in doing so in an axial position in which it completely releases the abutment component for adjustment of same, latches with the adjusting spindle. In this way, the ring or the hood, during the execution of adjustment work, can stay undetachably at the distribution valve and upon completion of the adjustment work again can be used for locking the adjustment.

Also it is, in the before mentioned embodiments of the distribution valve in which locking means are present by means of which in the respective adjusted axial position of the abutment component with respect to the adjusting spindle its rotatory position on the adjusting spindle can be locked, preferred that the locking means by means of a lead-sealing are secured or are securable, which when releasing the locking of the rotatory position of the abutment component on the adjusting spindle, which is effected by the locking means, is damaged or destroyed. Also through this it is visually recognizable if possibly an alteration of the originally adjusted maximum flow rate through the branch line has taken place or not, and it becomes furthermore possible to indicate who has performed a locked adjustment.

In still a further preferred embodiment, the distribution valve according to the invention is designed in such a manner that through an axial movement of the adjusting spindle in a direction pointing away from the branch line, the flow through the branch line can completely be stopped. By this, the distribution valves according to the invention can also be used as isolating valve and thus make possible for example a temporary complete separation of an individual circuit fed by them from the overall system, e.g. for the purpose of exchanging a water-bearing component in the circuit.

A second aspect of the invention concerns a distribution arrangement comprising at least two distribution valves according to the first aspect of the invention.

A third aspect of the invention concerns an adjusting unit for the distribution valve according to the first aspect of the invention.

A fourth aspect of the invention concerns an adjusting and measuring unit for the distribution valve according to the first aspect of the invention.

Such distribution arrangements and adjusting or adjusting and measuring units constitute preferred commercializations of the invention.

### BRIEF DESCRIPTION OF THE DRAWINGS

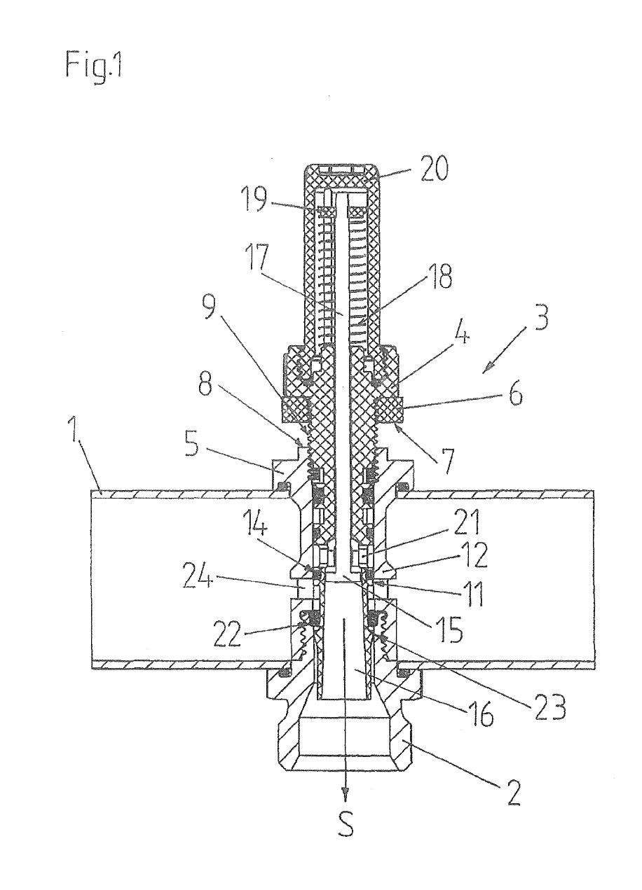

Further advantages and applications of the invention become apparent from the following description by means of the FIGS. 1 to 6, which show sectional views of a distribution valve with flowmeter according to the invention in different adjustments or situations, respectively.

### MODES FOR CARRYING OUT THE INVENTION

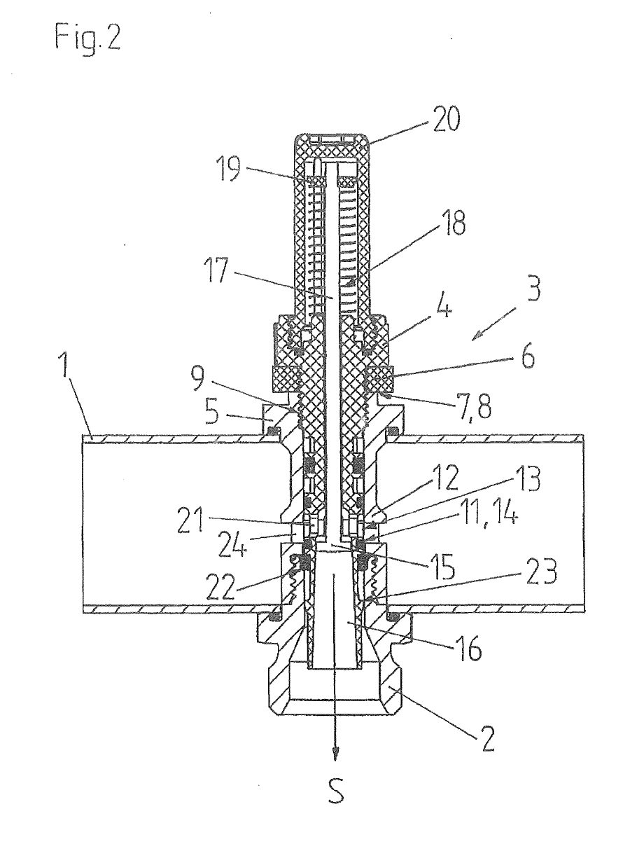

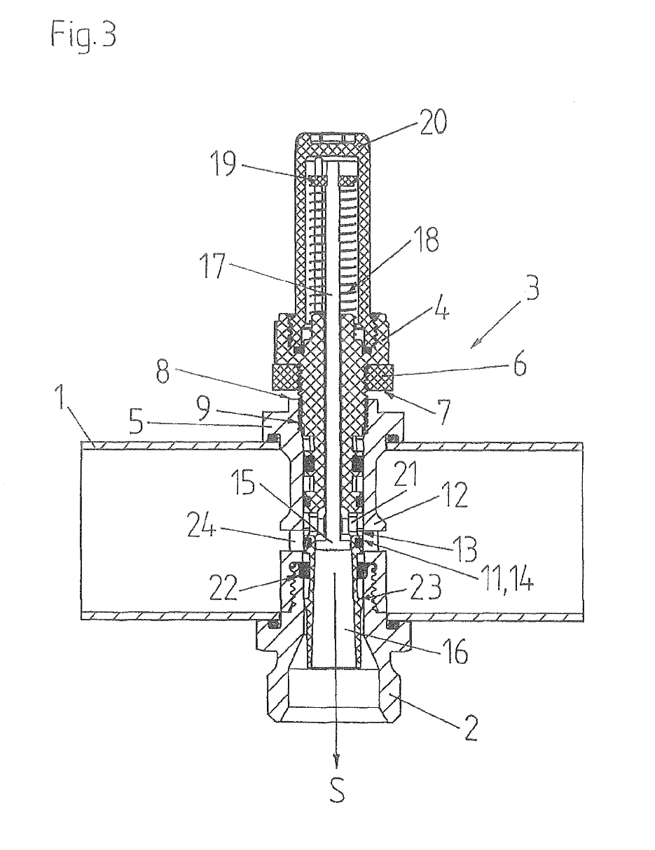

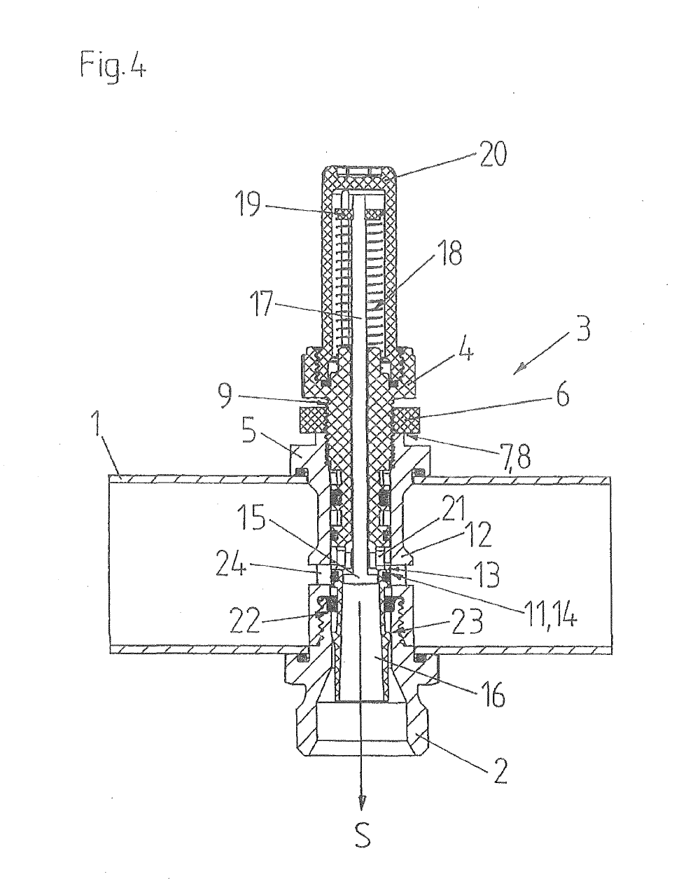

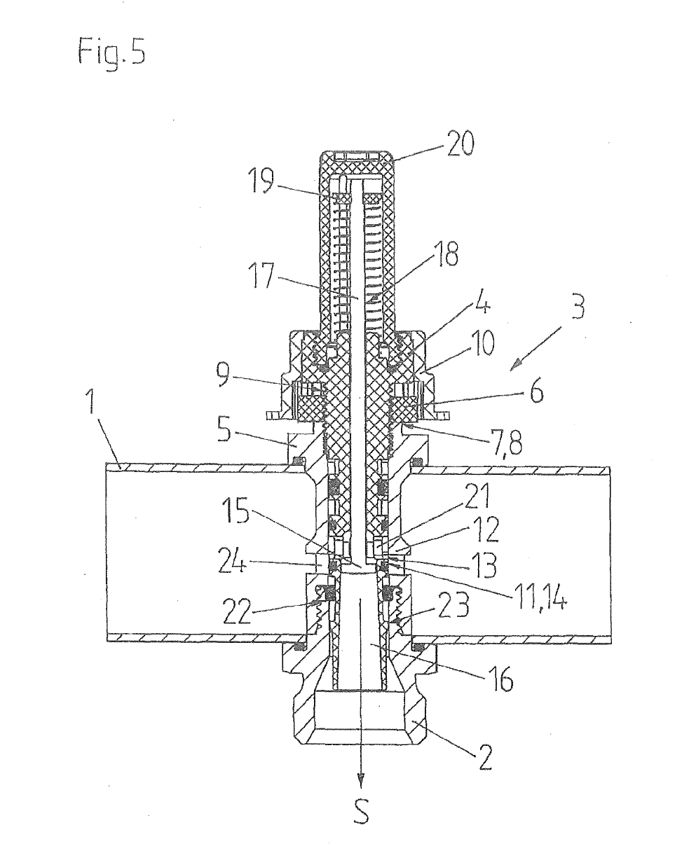

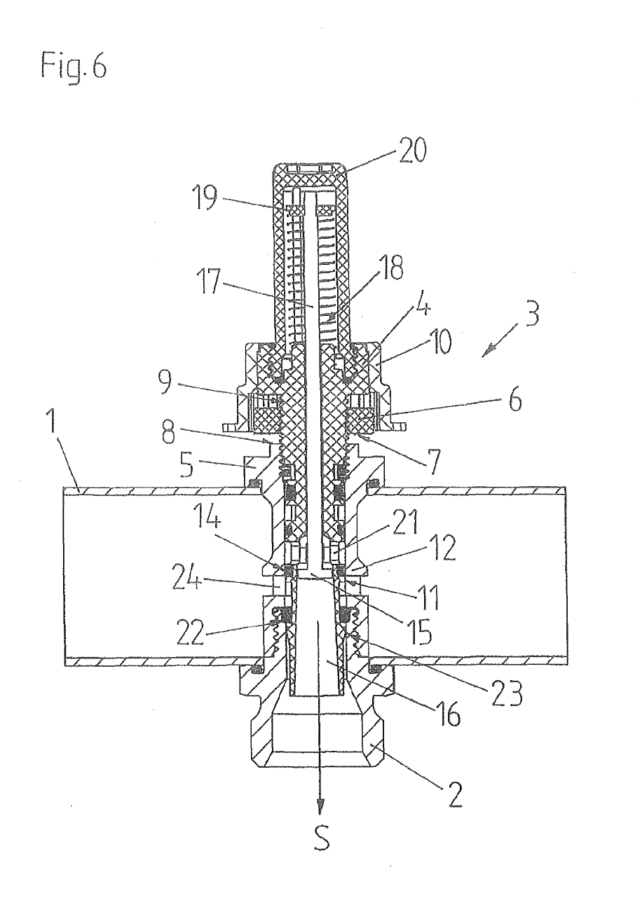

The FIGS. 1 to 6 show intersections with identical cutting lines through a distribution valve with flowmeter according to the invention in different adjustments and situations, namely with the valve completely closed (FIG. 1), with the valve completely opened (FIG. 2), with the valve adjusted to a specific flow rate, once without the abutment nut 6 being adjusted accordingly (FIG. 3), once with the abutment nut 6 being adjusted accordingly (FIG. 4) and once with the abutment nut 6 locked in the adjusted position (FIG. 5), as well as with the valve completely closed and the abutment nut 6 locked in the adjusted position (FIG. 6).

All representations show the valve in each case in the non-flown-through state, which is why the indication of the flowmeter, which in the following will still be discussed more into detail, in all representations does not show any flow rate.

The illustrated distribution valve is intended for the control of the flow rate through a warm water heating circuit and has been formed by introducing and mutual screwing together an adjusting and measuring unit 3 and a branch line 2 from the outside into two opposite receiving openings formed in a distribution manifold 1 having several such valves (only the detail with this valve is shown), which distribution manifold serves as housing and feed line.

The branch line 2 here serves as discharge line and in the present case at its free end is equipped with an outer thread for connection to the feed line of the warm water heating circuit.

The adjusting and measuring unit 3 serves for the adjusting and indicating of the warm water flow rate through the branch line 2 and comprises all components except the branch line 2 and the distribution manifold 1 which forms the housing. It comprises a sleeve-shaped valve closing body 11 carried by an adjusting spindle 4, which forms, by concentrically plunging into a cylindrical bore hole of a valve seat body 12 which in the intended use is static with respect to the distribution manifold, together with this valve seat body 12 a valve gap 13 which is adjustable by twisting the adjusting spindle 4, such that the valve gap width with an increasing plunging of the valve closing body 11 into the cylindrical bore hole of the valve seat body 12 decreases, until no valve gap 13 is present any more and the valve is completely closed. The actual sealing at completely close valve takes place via a sealing ring 14.

The flowmeter of the adjusting and measuring unit 3 has a button-like inflow member 15, which is positioned inside a conical flow channel 16 which flow channel succeeds the valve closing body 11 and as well is carried by the adjusting spindle 4. In the intended use, the water coming from the valve gap 13 flows, via several radial openings 21 into the valve closing body 11 and from same into the flow channel 16, which it completely flows through before it leaves the distribution valve via the branch line 2.

The inflow member 15 is connected to an indicator rod 17, which by a spiral spring 18 is acted upon with a spring force in direction against the flowing through direction S through the flow channel 16.

In doing so, the inflow member 15 is arranged in the flow channel 16 in such a manner that it, together with the indicator rod 17, starting from a starting position in which it is positioned by the spring loaded indicator rod 17 when the flow channel 16 in not flown through, is displaced in dependence of the flow rate against the spring force when the flow channel 16 is flown through, so that a specific axial position of the inflow member 15 and of the indicator rod 17 in the flow channel 16 corresponds to a specific flow rate through the flow channel 16 and therewith also through the branch line 2. The free end of the indicator rod 17 which is facing towards the outside comprises a plate-like thrust bearing 19 for the spring 18, which at its circumference is marked with color and thus constitutes an indicator mark. It is completely surrounded by a transparent plastic hood 20. This plastic hood 20 is fixedly connected with the adjusting spindle 4, so that it can serve as adjusting member for the manual actuation of the adjusting spindle 4 and upon twisting of same axially displaces together with same with respect to the components of the distribution valve that are stationary with the housing. The transparent plastic hood 20 in axial direction is furnished with a scaling (not shown) for the flow rate, so that the respective position of the indicator rod 17 with respect to the scaling on the plastic hood 20 and therewith also the flow rate through the branch line 2 can be red from the outside.

The valve seat body 12 is formed from the base body 5 of the adjusting and measuring unit 3, which combines all main components of the adjusting and measuring unit to one unit and via a thread is firmly connected with the branch line 2. In doing so, the two components 5, 2 in each case are sealed with respect to the distribution manifold 1 by a sealing ring. Due to the fact that the valve seat body 12 is formed by the base body 5 of the adjusting and measuring unit 3, the advantage results that between the valve closing body 11 and the valve seat body 12, independently of any manufacturing tolerances of the distribution manifold 1 and/or of the branch line 2, there always exists an exact alignment and that the dimensional accuracy of these components can be ensured in an easy manner, so that the desired control characteristic and tightness is always guaranteed.

The inflow from the feed line formed by the distribution manifold 1 to the valve gap 13 formed by the valve closing body 11 and the valve seat body 12 takes place via four radial flowing through openings 24, which at a common axial position are equally distributed at the circumference of the base body 5 of the adjusting and measuring unit 3.

The flow channel 16 is formed by the same component which also forms the valve closing body 11. In this way, those walls, which define the flow channel 16 in the area in which the inflow member 15 in the intended use can be positioned by the flow forces and which therefore are of specific importance for the accuracy of measurement, are formed by a component of the adjusting and measuring unit 3, what provides the advantage that between the mentioned walls of the flow channel 16 and the inflow member 15, independently of any manufacturing tolerances of the distribution manifold 1 and/or of the branch line 2, in a simple manner an exact axial as well as radial alignment is reached and that the dimensional accuracy of these components can be ensured in a simple manner, so that a high accuracy of measurement is guaranteed.

The adjusting spindle 4, the valve closing body 11 and the flow channel 16 are mutually formed by a one-piece injection-molding plastic part, by what such distribution valves consist of relative few individual components and can especially cost-efficiently be manufactured.

As can clearly be recognized, the flow channel 16 is formed by a free end having a cylindrical outer contour of the component which also forms the valve closing body 11, wherein this free end axially extends into a bore hole of the branch line 2.

In order to avoid the formation of a leakage flow into the branch line 2, which would bypass the flow channel 16 and thus would lead to an incorrect measurement, this free end is radially sealed against the branch line 2 by a sealing 22 in such a way that a rotation as well as an axial translatory movement of this free end is possible without impairing the sealing function. This sealing 22 also seals the base body 5 of the adjusting and measuring unit 3 and the branch line 2 against each other. Also, this sealing 22 serves as axial stop for an abutment shoulder 23 arranged at the outer circumference of the component which is forming the flow channel 16, which abutment shoulder prevents an unscrewing and removal of the adjusting spindle 4 out of the base body 5 of the adjusting and measuring unit 3.

As has been mentioned already, the inflow of the water coming from the valve gap 13 into the entry zone of the flow channel 16 takes place via several radial openings in the wall of the sleeve-shaped valve closing body 11, which as seen in flow direction S are arranged before the inflow member 15 which is in the starting position when the flow channel 16 is not flown through. There are four radial openings 21 with in each case identical cross section and identical cross sectional shape arranged at a common axial position distributed equally at the circumference of the sleeve-shaped valve closing body 11. This construction principle leads to a uniform inflow to the inflow member 15 in the flow channel 16, by what a steady indication and thus a good readability of the flow rate can be achieved.

As becomes visible in synopsis of the FIGS. 1 to 3, the valve gap 13 is, starting from the fully closed situation depicted in FIG. 1, through a twisting of the adjusting spindle 4 relative to the base body 5 of the adjusting and measuring unit 3 in such manner that it axially moves towards the branch line 2, opened or increased, respectively, until a maximum valve gap opening as depicted in FIG. 2 is reached. In the intended use, the flow rate through the branch line 2 is thereby increased accordingly, wherein typically a valve gap opening 13 is adjusted which lies between these two extremes, in order to achieve a specific flow rate through the branch line which lies within the adjustment range of the distribution valve, e.g. a valve gap opening 13 as depicted in FIG. 3.

In order to lock this adjustment, e.g. starting from the adjustment depicted in FIG. 3, the abutment nut 6 which is arranged at the thread 9 of the adjusting spindle 4 is twisted on this thread relative to the adjusting spindle 4, until it abuts with its face 7 (first abutment face according to the claims) facing towards the branch line 2 against the face 8 of the base body 5 of the adjusting and measuring unit 3 (second abutment face according to the claims). This situation is depicted in FIG. 4.

Thereafter, the abutment nut 6 is locked in this position against a twisting relative to the adjusting spindle 4 by means of a locking hood 10, which in axial direction towards the branch line 2 is pushed onto the adjusting spindle 4 and the abutment nut 6 and by doing so in a rotatably positive locking manner engages contours formed at the circumference of the adjusting spindle 4 and at the circumference of the abutment nut 6. In doing so, the hood 10 latches in axial direction with the abutment nut 6. This situation is depicted in FIG. 5.

In case starting from this situation depicted in FIG. 5 the flow rate through the branch line 2 shall temporarily be reduced or the valve shall temporarily be closed, without the need that the originally adjusted flow rate after that has again to be determined, the adjusting spindle 4 together with the abutment nut 6 and the locking hood 10 is twisted relative to the base body 5 of the adjusting and measuring unit 3 in such a manner that it moves relative to the base body 5 in axial direction away from the branch line 2 until the desired situation is reached.

FIG. 6 shows the situation in case that the distribution valve is temporarily completely closed. In order to readjust the valve starting from this situation to the originally adjusted flow rate through the branch line 2, it is merely necessary to again twist the adjusting spindle 4 together with the abutment nut 6 and the locking hood 10 relative to the base body 5 of the adjusting and measuring unit 3 in opposite direction, until the abutment nut 6 with its face 7 abuts against the face 8 of the base body 5 of the adjusting and measuring unit 3.

In case another flow rate through the branch line 2 has to be adjusted, the locking hood 10 must be pulled away from the abutment nut 6 and the adjusting spindle 4, and then the steps described before must again be performed.

While in the present application there are described preferred embodiments of the invention, it is to be distinctly understood that the invention is not limited thereto and may by otherwise variously be embodied and practiced within the scope of the following claims.

1. Distribution valve for the use in the feed or the return of a medium circuit for heating or cooling, with a housing forming the feed line or the return line, respectively, a branch line branching off from the housing and an adjusting unit for adjustment of a flow of medium through the branch line, which adjusting unit is formed separately from the housing and opposite to the branch line is arranged at the housing and protrudes the housing wall,
wherein the adjusting unit comprises an adjusting spindle, the axial position of which with respect to a component of the adjusting unit which in particular is fixedly connected to the housing can be changed by twisting it relative to said component, thereby changing the flow rate through the branch line,
wherein the valve is designed in such a manner that an axial movement of the adjusting spindle relative to the component in direction towards the branch line effectuates an increase of the flow rate through the branch line, and
wherein adjustable stopper means are present by means of which, through abutting of a first abutment face which is connected with the adjusting spindle against a second abutment face which is connected with the housing, an axial movement of the adjusting spindle with respect to the component in direction towards the branch line is limited at a specific axial position, for limiting the maximum flow rate through the branch line that can be adjusted.

2. Distribution valve according to claim 1, wherein the second abutment face is formed by or is connected with the component of the adjusting unit which is connected with the housing and with respect to which the axial position of the adjusting spindle can be changed by twisting.

3. Distribution valve according to claim 1, wherein the first abutment face is facing towards the branch line and wherein it, for limiting the maximum flow rate through the branch line that can be adjusted, in axial direction abuts against the second abutment face.

4. Distribution valve according to claim 1, further comprising a measuring unit for measuring and indicating at the outside of the distribution valve a flow rate of medium through the branch line.

5. Distribution valve according to claim 4, wherein the adjusting unit and the measuring unit are commonly formed as a combined adjusting and measuring unit.

6. Distribution valve according to claim 1, wherein the adjustable stopper means in the adjusted position can be locked.

7. Distribution valve according to claim 1, wherein the position, in particular the axial position of the first abutment face is adjustable with respect to the adjusting spindle.

8. Distribution valve according to claim 7, wherein the first abutment face is formed by an abutment component which is mounted on a thread of the adjusting spindle, such that its axial position with respect to the adjusting spindle can be adjusted by twisting it relative to the adjusting spindle.

9. Distribution valve according to claim 7, wherein the second abutment face is fixedly connected with the housing or with the component, respectively, relative to which the axial position of the adjusting spindle by twisting can be changed.

10. Distribution valve according to claim 1, wherein the position, in particular the axial position of the second abutment face with respect to the housing or the component, respectively, relative to which the axial position of the adjusting spindle by twisting can be changed, is adjustable.

11. Distribution valve according to claim 10, wherein the first abutment face is firmly connected with the adjusting spindle.

12. Distribution valve according to claim 6, wherein locking means are present, by means of which in the respective adjusted axial position of the abutment component with respect to the adjusting spindle its rotatory position on the adjusting spindle can be locked, in particular can be locked by positive locking.

13. Distribution valve according to claim 12, wherein the locking means comprise a ring or a hood, which in a rotatably positive locking manner engages contours formed at the circumference of the adjusting spindle and at the circumference of the abutment component or in a positive manner encompasses such contours.

14. Distribution valve according to claim 13, wherein the valve is designed in such a manner that for locking the rotatory position of the abutment component, the ring or the hood is pushed in axial direction towards the branch line onto the abutment component.

15. Distribution valve according to claim 14, wherein the ring or the hood in the position, in which it locks the rotatory position of the abutment component, axially latches with the abutment component and/or with the adjusting spindle.

16. Distribution valve according to claim 15, wherein this latching can be cancelled only by damaging or destroying the ring or the hood.

17. Distribution valve according to claim 13, wherein the valve is designed in such a manner, that the ring or the hood for releasing the locking of the rotatory position of the abutment component has to be removed from the abutment component in an axial direction pointing away from the branch line, and in particular, that the ring or the hood in doing so, in an axial position in which it completely releases the abutment component for adjustment of same, latches with the adjusting spindle.

18. Distribution valve according to claim 12, wherein the locking means by means of a lead-sealing are secured or are securable, which upon releasing the locking of the rotatory position of the abutment component on the adjusting spindle, which is effectuated by the locking means, is damaged or destroyed.

19. Distribution valve according claim 12, wherein the valve is designed in such a manner that through an axial movement of the adjusting spindle in a direction pointing away from the branch line the flow through the branch line can completely be stopped.

20. Distribution arrangement comprising at least two distribution valves according to claim 12.

21. Adjusting unit for the distribution valve according to claim 1.

22. Adjusting and measuring unit for the distribution valve according to claim 1.
